(19) United States
(12) Patent Application Publication
(10) Pub. No.: US 2015/0317587 A1
(43) Pub. Date: Nov. 5, 2015

(54) METHODS FOR MINIMIZING WAIT TIMES FOR THEME PARK PATRONS

(71) Applicant: Sam Najjar, Yucaipa, CA (US)

(72) Inventor: Sam Najjar, Yucaipa, CA (US)

(21) Appl. No.: 14/267,065

(22) Filed: May 1, 2014

(51) Int. Cl. G06Q 10/06

(52) U.S. Cl. CPC G06Q 10/06314

(57) ABSTRACT

In accordance with the present invention, there are provided methods for minimizing the amount of time theme park patrons wait in line until being able to partake of a given attraction and/or a pre-selected plurality of attractions.

### FIELD OF THE INVENTION

The present invention relates to methods for minimizing the amount of time theme park patrons wait in line until being able to partake of a given attraction.

### BACKGROUND OF THE INVENTION

The information provided herein and references cited are provided solely to assist the understanding of the reader, and does not constitute an admission that any of the references or information is prior art to the present invention.

Wait times to experience attractions at theme parks has been a major problem for park management and visitors alike. Reducing or eliminating wait time has been a goal of park managers for years. While a few patents have been awarded in the area of persons flow management as it pertains to theme parks (e.g., amusement parks), the efficacy of existing systems is limited as they depend on using the age old concept of “first-come, first-served” and such improvements thereof as the issuance of a priority boarding pass for patrons who may stop by the attraction, find it too busy, get a ticket to come back at some designated later time with a higher boarding priority.

Recent developments have focused on the use of wireless technology to send cell phone messages to manage priority, the availability of the attraction as well as urging crowd relocation from one area to another. Theme park operators have used monitoring devices to track the amount of time patrons spend at different attractions to better manage the line queue. In spite of these efforts, wait times can still vary substantially depending on a variety of factors, such as the popularity of a particular attraction, the time of day, the day of the week, the number of visitors in the theme park on a particular day, and the like.

### SUMMARY OF THE INVENTION

In accordance with the present invention, there are provided methods for minimizing the amount of time theme park patrons wait in line until being able to partake of a given attraction. By reducing patron wait time, patrons can experience a maximum number of rides during a visit to the theme park. For example, if the wait time is reduced to 5 minutes per ride, a park visitor will be able to experience a substantial number of rides (an average of 24 to 30 different rides and attractions on a single day's visit). Notably, the park patron would be subjected to no more than 2 to 2.5 hours total waiting time for all the rides combined. This is comparable to the amount of wait time a patron would have to endure to partake of but a single ride under the existing “first-come, first-served” systems.

Patron free time generated as a result of this enhanced efficiency can be spent in a variety of ways while the patron remains on the park grounds, e.g., shopping, eating, entertaining, and the like. In addition, fewer park employees will be needed to manage lines due to the enhanced efficiency of attraction utilization and patron distribution among the various attractions at a theme park, and the resulting reduction in the number of patrons spending substantial amounts of time waiting in lines.

Park patrons will realize numerous benefits and advantages upon implementation of invention methods, providing enhanced customer satisfaction as a result of:
A. Patrons spending less than 5 minutes on average waiting to enter an attraction (instead of 90 minutes or more as frequently experienced under the currently prevailing “first-come, first-served” protocol).
B. Patrons can select the times (and rides) that they prefer to experience. There is strong incentive to do so. The further in advance a patron identifies their preferences, the better; the earlier one books, the more control one will have over how their time will be spent while at the theme park. Thus, the invention method provides enhanced predictability to both the patron and the park operator.
C. The invention method facilitates park utilization by large groups—who can readily arrange to ride together, especially when they book tickets sufficiently in advance.
D. Patrons have the ability to pick and choose which attractions to attend and which ones to skip without any negative impact on one's boarding priority for the selected attractions.

Park operators will also realize numerous benefits and advantages upon implementation of invention methods, providing enhanced revenue as a result of:
A. Reduced head count (as fewer workers will be needed to manage lines awaiting entry into a specific attraction). The park can operate more efficiently with fewer staff members and/or re-deploy staff members to other tasks.
B. Patrons will spend more time in the park shopping and spending money on food, gifts and other activities instead of “dead time” waiting in line. The substantial wait time created by the currently employed systems (often referred to as “unrealized revenue”) do not bring in any revenue. By eliminating this non-productive time, park vendors will likely realize more revenue from such items as food, gifts and other activities.
C. Customers are more likely to make a return visit to the park if they are able to experience a substantial number of attractions during a given park visit. By making it possible for patrons to experience all of the available attractions, the chance of a patron returning to the park are maximized (since the odds of a patron experiencing one or more attractions for which they wish to return would be maximized).
D. Advanced ticket purchasing will increase as a result of implementing the invention methods, which, in turn, leads to higher revenue and greater predictability of required staffing levels, vendor stock, etc.
E. As a result of patrons being able to experience more attractions, they will have the opportunity to pass through more of the strategically placed stores near ride exits, thereby increasing foot traffic and improving sales and revenue.
   The above-noted advantages of invention methods can be achieved without the need for specialized park operator-supplied equipment, such as hand-held pagers, GPS devices, bracelets, and the like.

Implementation of the invention methods not only allows the park operator to publicize the ability to reduce wait times at their park, implementation of the invention methods also provides the park operator with information regarding where park patrons are likely to be at all times throughout the park. Therefore, the park operator may be able to access information regarding what age group(s) or demographics are partaking of particular attraction(s), which, in turn, might allow the park operator to do intelligent marketing and targeting of park visitors to maximize sales and increase the bottom line.

Invention methods can be carried out exclusively, or in conjunction with the existing “first-come, first-served” system if the park operator elects to do so. For instance, the park operator might elect to offer only first-come, first-served boarding during certain hours, while offering access to the invention priority method to a least a portion of the park patrons during other hours. Alternatively, the park operator may elect to book a defined percentage of the patrons on a given day (or portion of a day) under the invention method, while leaving a defined percentage for line seekers. As a further alternative, the park operator may elect to book a defined number of the attractions on a given day (or portion of a day) under the invention method, while leaving a defined percentage of attractions for line seekers.

Gradual implementation of the invention method (e.g., a pilot period) might be employed. For example, 50% of the capacity of a given attraction can be designated to be booked under the invention methods, while the other 50% can continue to stand in line according to the existing first-come, first-served protocol and the fast pass protocol. As park management gains more insights as to the demand for various attractions, the percentage of patrons allowed to book under the invention method can be increased; indeed, in due course, the park operator may elext to phase out the old system altogether.

In addition, the invention method may include the designation of a period of “open” unscheduled times for those who miss certain attractions to go back and enjoy rides they might have missed. This is usually best scheduled at a slower time of the day such as the last hour of park operation, dinner time, while a parade is underway, or the like.

### BRIEF DESCRIPTION OF THE FIGURES

FIG. 1 shows an exemplary theme park environment to which invention methods can be applied. The theme park environment illustrated herein comprises a plurality of zones, wherein each zone also comprises a plurality of attractions.

FIG. 2 shows another exemplary theme park environment to which invention methods can be applied. The theme park environment illustrated herein comprises at least 2 separate and distinct theme parks, each of which comprise a plurality of zones, wherein each zone also comprises a plurality of attractions.

### DETAILED DESCRIPTION OF THE INVENTION

In accordance with the present invention, there are provided methods for minimizing the wait time for admission of an individual patron or a plurality of patrons to a pre-selected plurality of attractions in a theme park,

wherein:
the theme park comprises a plurality of patrons seeking to partake of a plurality of attractions,
the plurality of attractions is selected from the group consisting of a ride, live entertainment, recorded entertainment, a restaurant, a snack bar, and a museum, but not including a hotel, a spa, a golf course, a water park, or the like;
each attraction operates in either a batch-fill mode or constant throughput mode;
each attraction operating in a batch-fill mode has a pre-determined attraction capacity per run cycle, wherein each run cycle is of a pre-determined duration,
each attraction operating in a constant throughput mode allows for a range of transit times through said attraction;
each patron may optionally express one or more preferences regarding which attractions to visit and when, the sequence of attractions to visit, the time allotted between entry into each attraction, and, for attractions operating in the constant throughput mode, the time allotted to visit each such attraction, and
patrons are permitted access to each attraction on a priority basis established by a schedule which allocates report time(s) for each attraction, and optionally, for those who elect not to obtain boarding priority, on a first-in, first-out basis.
   Invention methods consisting essentially of:

transmitting to each patron, via a suitable vehicle, a schedule of report time(s) for one or more attraction(s) for which said patron would like to gain entry, wherein said suitable vehicle requires no park operator-supplied equipment; and wherein the schedule is established taking into account a plurality of the following criteria:
the number of patrons authorized to enter a given attraction at a given report time,
the duration of the run cycle for each attraction,
whether the attraction operates in a batch-fill mode or constant throughput mode,
when a request for priority boarding is submitted,
the patron's personal preferences; and
the relative distance between the attractions that the patron wishes to experience;

populating the attraction up to a pre-determined percentage of the attraction capacity with patrons having the allocated report time, without reserving space for patrons having the allocated report time who are not present at the attraction at the allocated time, and thereafter

optionally, at the park operator's discretion, populating as much or as little of the remaining capacity of said attraction as deemed appropriate with patrons awaiting boarding on a first-in, first-out basis.

As reflected by the use of “consisting essentially of” language herein, no other components (e.g., no park operator-supplied equipment) are required to implement invention methods.

As used herein, the term “theme park” refers to a venue where a plurality of patrons seek to partake of a plurality of attractions, e.g., rides, shows, and the like; however, as used herein, “theme park” does not include venues dedicated to a single activity (e.g., a golf course, a water park, and the like) or a venue which provides overnight accommodations (e.g., a hotel, a campground, and the like).

As used herein, the term “attractions” refers to a variety of passive and/or interactive activities, e.g., rides, live entertainment, recorded entertainment, restaurants, snack bars, museums, and the like. As used herein, attractions do not include hotels, spas, golf courses, water parks, and the like.

As used herein, reference to the fact that the “suitable vehicle requires no park operator-supplied equipment” reflects the fact that invention methods can be readily implemented without investment in any specialized equipment designed specifically for such purpose. This speaks to the elegant simplicity of the invention methods, whereby wait times for theme park patrons are substantially reduced without incurring major expenses to implement same.

Thus, according to the present invention, attractions in a theme park are preferentially populated according to patron preference, wherein patrons are given the opportunity to identify their preferences well in advance of actual attendance. A particular advantage of the invention method is the ability to not only minimize the amount of time that a patron waits for admission to a particular attraction, in addition, implementation of the invention methods minimizes the amount of walking required to partake of attractions of interest.

As used herein, the phrase a “plurality of patrons” refers to the number of patrons in attendance at a theme park. Typically the number can vary from hundreds to thousands. In certain aspects, the number of patrons will be less than the total capacity of all attractions in a theme park. In other aspects, the number of patrons will exceed the total capacity of all attractions in a theme park.

As used herein, the phrase “plurality of attractions” refers to the number of attractions which comprise a theme park (also referred to herein as an“amusement park”). A typical theme park comprises 2 or more attractions; 5 or more attractions; 10 or more attractions; 15 or more attractions; 20 or more attractions; 25 or more attractions; 30 or more attractions; 35 or more attractions; 40 or more attractions; 45 or more attractions; 50 or more attractions; 55 or more attractions; 60 or more attractions; 65 or more attractions; 70 or more attractions; 75 or more attractions; 80 or more attractions; 85 or more attractions; 90 or more attractions; 95 or more attractions, 100 or more attractions; and the like.

In certain embodiments, the plurality of attractions is located in a plurality of zones about the theme park environment. Each zone comprises two or more attractions in relative close proximity to one another (frequently related to one another by a common theme), wherein the remaining attractions in the theme park are separated from the attractions in the same zone by a substantial distance which requires substantial transit time therebetween.

In certain embodiments, one or more attractions (or zones) are located within easy access of the patron's location (e.g., attractions which require less than 5 minutes to travel from a first attraction (or zone) to a second attraction (or zone) by foot or by assisted transport). In certain embodiments, it may require more than 5 minutes to travel from a first attraction (or zone) to a second attraction (or zone) by foot or by assisted transport. In determining the timing and sequence of attractions which a patron will experience, the invention method takes into account the proximity of one attraction (or zone) to another, the ease of transit from one attraction (or zone) to another, the mobility of each patron (i.e., does the patron have any mobility issues with would require special assistance and/or the allotment of additional time for transit from one attraction to another), and the like.

In certain embodiments, the plurality of attractions (or zones) is connected by one or more forms of public transportation (e.g., a train, a tram, a moving sidewalk, and the like). In certain embodiments, the plurality of zones is connected by one or more forms of personalized transportation (e.g., a golf cart, a Segway, and the like).

In certain embodiments, the patron may elect to remain in a single zone within said theme park environment. In certain embodiments, the patron may elect to experience a plurality of zones within said theme park environment.

In certain embodiments, the patron may elect the time of day in which to visit a specific zone. For example, a patron may wish to visit certain attractions early in the day, before lunch, during lunchtime, after lunch, before dinner, during dinnertime, after dinner, shortly before closing of the theme park, and the like.

In certain embodiments, the patron can specify which zone(s) within the theme park environment the patron wishes to visit and when.

As readily recognized by those of skill in the art, the personal preferences of each patron (or group of patrons) can be obtained in a variety of ways, e.g., such preferences can be self-booked, solicited at the time of ticket purchase, solicited at the time of entry to the theme park environment, solicited on-site after entry to the theme park environment, attributed to each patron by default in the absence of explicit request, etc.

In certain embodiments, the theme park is equipped with a plurality of readily visible synchronized clocks to avoid any confusion as to when each patron is scheduled to report to a given attraction.

In certain embodiments, each patron will have the ability to express their preference with respect to a variety of parameters related to the time and location of attractions of which they wish to partake, such as, for example, one or more of the following:
which attractions to visit, and when to visit same,
the sequence with which one desires to visit the attractions (including the specification of which attraction is to be visited first, or last),
designated companions with whom said patron wishes to coordinate schedules,
requested stops (including rest stops, bathroom stops, meal stops, and the like.).

As readily recognized by those of skill in the art, a wide variety of readily available vehicles can be employed to facilitate communication of a patron's request to a centralized database (and the communication of one's priority schedule from said centralized database), such as, for example, a map, a smart-phone, text message, an email, and the like. Said vehicle may optionally further comprise additional features such, as, for example, a timer, a reminder alert, and the like. The use of such vehicles does not require the park operator to supply any specialized equipment to park patrons to facilitate communication therewith.

The centralized database contemplated for use herein monitors a number of parameters related to theme park utilization, typically taking into account a plurality of the following parameters:
the number of patrons allowed to enter a given attraction,
the duration of the run cycle for each attraction,
the distance between attractions,
the volume of patrons in the theme park environment,
attractions which are unavailable on a given day,
attractions which are temporarily off-line,
attractions which are excessively congested,
weather conditions (excessively hot day, excessively humid),
and the like.

In certain embodiments of the present invention, no greater than about 5% of the capacity of a given attraction is populated by patrons having the allocated report time.

In certain embodiments of the present invention, no greater than 10% of the capacity of a given attraction is populated by patrons having the allocated report time.

In certain embodiments of the present invention, no greater than 20% of the capacity of a given attraction is populated by patrons having the allocated report time.

In certain embodiments of the present invention, no greater than 30% of the capacity of a given attraction is populated by patrons having the allocated report time.

In certain embodiments of the present invention, no greater than 40% of the capacity of a given attraction is populated by patrons having the allocated report time.

In certain embodiments of the present invention, no greater than 50% of the capacity of a given attraction is populated by patrons having the allocated report time.

In certain embodiments of the present invention, a given attraction is populated primarily (e.g., at least 51% of capacity) by patrons having the allocated report time.

In certain embodiments of the present invention, a given attraction is populated predominantly (e.g., at least 70 up to about 80% of capacity) by patrons having the allocated report time.

In certain embodiments of the present invention, a given attraction is populated exclusively (i.e., 100% of capacity by patrons having the allocated report time.

In certain embodiments of the present invention, only a portion of the attractions in the theme park are subject to the methods described herein.

In certain embodiments of the present invention, no greater than 10% of the attractions in the theme park are subject to the methods described herein.

In certain embodiments of the present invention, no greater than 20% of the attractions in the theme park are subject to the methods described herein.

In certain embodiments of the present invention, no greater than 30% of the attractions in the theme park are subject to the methods described herein.

In certain embodiments of the present invention, no greater than 40% of the attractions in the theme park are subject to the methods described herein.

In certain embodiments of the present invention, no greater than 50% of the attractions in the theme park are subject to the methods described herein.

In certain embodiments of the present invention, the majority of the attractions (i.e., greater than 50% of the attractions) in the park are subject to the methods described herein.

In certain embodiments of the present invention, substantially all of the attractions (e.g., at least 70-80% of the attractions) in the park are subject to the methods described herein.

In certain embodiments of the present invention, all of the attractions (i.e., 100% of the attractions) in the park are subject to the methods described herein.

Attractions which operate in a batch-fill mode operate in a discontinuous mode, whereby a set number of patrons are admitted to an attraction (up to the maximum capacity thereof), then the experience to which all patrons are subjected is substantially the same (e.g., a stage show, a movie, and the like). Once the planned program is complete, all patrons are dismissed from the attraction, and subsequently a new group of patrons is admitted.

Attractions which operate in a constant throughput mode provide continuous entertainment whereby patrons pass through the attraction while the entertainment continues uninterrupted. Each patron may enjoy a different experience depending upon when they enter the attraction. In some instances, the rate of passage through the attraction may be dictated by the park operator (e.g., by a moving sidewalk, a moving transport vessel, or the like) and in some instances, the rate of passage through the attraction may be somewhat at the patron's discretion (e.g., a self-guided tour, observation decks to pause and reflect, and the like).

As used herein, “run cycle” refers to the duration of an attraction operating in a batch-fill mode, exclusive of the time to seat the patrons therein; or the average amount of time for a patron to traverse an attraction operating in a constant throughput mode.

### The Protocol:

A central database (e.g., a computer equipped with persons flow management software) assigns boarding times and generates a schedule for all of the attractions and rides requested by the patron (e.g., at the time of purchasing the ticket, at the time of admission, and the like). The generated schedule can be communicated to the patron in a variety of way, for example, one or more methods including e-mail, text, hard copy, or using an electronic device capable of narrating the schedule and alerting the patron to go to the next scheduled attraction. Such a device is optionally capable of giving a map and directions. The same may be achieved with a cell phone equipped with an application capable of reading and displaying the generated schedule. Patrons will then be requested to assemble at the designated waiting area of the specific attraction no more than 5 minutes before the scheduled boarding time. Only the group that is going on the specific ride at the specified time will be waiting in line. All in line will enter the attraction. This eliminates excessive lines, excessive waiting time and the burden of very large crowd management.

### The Sequence of Attractions (the Itinerary):

Among the factors to be considered in generating a schedule, the sequence of rides and attractions is taken into account. Thus, minimizing the amount of walking between attractions is taken into account. Therefore, the proximity of attractions is considered when the recommended ride sequence is established. Invention methods take this into account and minimize walking time between attractions by assigning adjacent attractions sequentially. The sequential attraction planning eliminates (or at least minimizes) patrons wasting time walking in search of a specific ride, another time saving advantage of the invention method.

Maximizing the effective time of patrons in the theme park is one of the goals of invention methods. Such benefit enhances the patron's experience and customer satisfaction, and also frees up patrons' time while in the theme park so that they can shop for souvenirs, food, refreshments, and the like.

By contrast, the existing system encourages patrons to walk away from rides and attractions because of long lines, adding to the amount of time wasted away from attractions and rides. The invention methods substantially eliminate this source of delay and dissatisfaction by pre-assigning report time(s) for selected attractions in a sequential manner.

A map of attractions, including a designation of where the patron should start, is provided to each patron; for example, such designation can be marked on the patron's ticket. Consequently, some patrons might start at an attraction close to the entrance of the park, some in the middle, and some patrons might start at the back end of the park. All attractions in between can also be starting points so that the patron population is spread over all available attractions at all times throughout the day so that the total crowd in attendance at the theme park is managed most effectively. This ensures efficiency and good flow of humanity throughout the park.

Other Advantages Associated with Invention Methods

Invention methods allow large group(s) of patrons to experience rides and/or attractions together at the same time. It will also allow a person purchasing in advance to have the option of selecting the times to enjoy certain attractions depending on the patron's preference. In addition, invention methods have the flexibility to allow each patron to select specific attractions, skipping attractions, and specifying desired times for lunch, refreshments and rest breaks. Most importantly, invention methods enhance park efficiency and maximize the effective time patrons spend while visiting the park by substantially reducing wait time.

Advanced booking allows visitors to tailor their theme park experience to their own attraction preferences. This might include, for example, selecting specific rides and shows or experiencing specified preferred attractions multiple times. However, park management may elect to limit the number of visits to specific (especially new) attractions. Park management may also allow multiple visits to the same attraction only during certain times during the day, e.g., before or after a certain time of the day to best manage the attraction.

As park management gains insight regarding patron utilization of the attractions in the park, they can also obtain valuable information about shopping and eating trends by tracking sales, transactions and times of transactions throughout the park. Such information might be used to strategically and timely position park vendors so as to maximize the sales of refreshments, food and other merchandise. If patrons age groups and demographics are also tracked, the marketing strategy can be refined and optimized further to maximize profitability.

In accordance with another embodiment of the present invention, there are provided methods for minimizing the wait time for admission of an individual patron or a plurality of patrons to an attraction in a theme park environment,

wherein:
said theme park environment comprises a plurality of patrons seeking to partake of a plurality of attractions,
each attraction operates in either a batch-fill mode or constant throughput mode;
each attraction operating in a batch-fill mode has a pre-determined attraction capacity per run cycle, wherein each run cycle is of a pre-determined duration,
each attraction operating in a constant throughput mode allows for a range of transit times through said attraction;
each patron may optionally express one or more preferences regarding which attractions to visit and when, the sequence of attractions to visit, which zone(s) within the theme park environment the patron wishes to visit and when, the time allotted between entry into each attraction, and, for attractions operating in the constant throughput mode, the time allotted to visit each such attraction, and
patrons are permitted access to each attraction on a priority basis established on a first-in, first-out basis, or by a schedule which allocates report time(s) for each attraction.
   Invention methods consist essentially of:

transmitting to each patron, via a suitable vehicle, a schedule of report time(s) for one or more attraction(s) for which said patron would like to gain entry, wherein the schedule is established taking into account the number of patrons authorized to enter a given attraction at a given report time, the duration of the run cycle for each attraction, when a request for priority boarding is submitted, and the patron's personal preferences;

populating the attraction up to a pre-determined percentage of the attraction capacity with patrons awaiting boarding on a first-in, first-out basis, and thereafter

optionally, at the operator's discretion, populating as much of the remaining capacity of said attraction as deemed appropriate, with patrons having the allocated report time, without reserving space for patrons having the allocated report time who are not present at the attraction at the allocated time.

Thus, according to this aspect of the present invention, attractions in a theme park are preferentially populated according to prior art “first-come, first-served” protocol, but patron preference is also taken into account for a select number of patrons, wherein such patrons are given the opportunity to identify their preferences well in advance of actual attendance.

In accordance with yet another embodiment of the present invention, there are provided methods for managing the loading of a plurality of patrons on a plurality of attractions in a theme park environment,

wherein:
said theme park environment comprises a plurality of patrons seeking to partake of a plurality of attractions,
each attraction operates in either a batch-fill mode or constant throughput mode;
each attraction operating in a batch-fill mode has a pre-determined attraction capacity per run cycle, wherein each run cycle is of a pre-determined duration,
each attraction operating in a constant throughput mode allows for a range of transit times through said attraction;
each patron may optionally express one or more preferences regarding which attractions to visit and when, the sequence of attractions to visit, which zone(s) within the theme park environment the patron wishes to visit and when, the time allotted between entry into each attraction, and, for attractions operating in the constant throughput mode, the time allotted to visit each such attraction, and
patrons are permitted access to each attraction on a priority basis established by a schedule which allocates report time(s) for each attraction, and optionally, for those who elect not to obtain boarding priority, on a first-in, first-out basis,
   said method consisting essentially of:

soliciting from each patron a priority request for allocation of report time(s) for one or more attraction(s) which said patron would like to experience, taking into account the number of patrons authorized to enter a given attraction at a given report time, the duration of the run cycle for each attraction, the time to be allotted between attractions, the number and location of the attractions of interest, when a request for priority boarding is submitted, and the patron's personal preferences, the priority request being entered into a centralized database that monitors the number of patrons allowed to enter a given attraction, and the duration of the run cycle for each attraction;

transmitting to each patron allocated report time(s) via a suitable vehicle,

populating the attraction up to a pre-determined percentage of the attraction capacity with patrons having the allocated report time, without reserving space for patrons having the allocated report time who are not present at the attraction at the allocated time, and thereafter

optionally, at the operator's discretion, populating the remaining capacity of said attraction with patrons awaiting boarding on a first-in, first-out basis.

Thus, according to the present invention, attractions in a theme park are preferentially populated according to patron preference, wherein patrons are given the opportunity to identify their preferences well in advance of actual attendance.

The invention will now be described in greater detail with reference to the following non-limiting examples.

### EXAMPLES

### Example 1

### Sequential Schedule for a Patron Visiting 20 Attractions

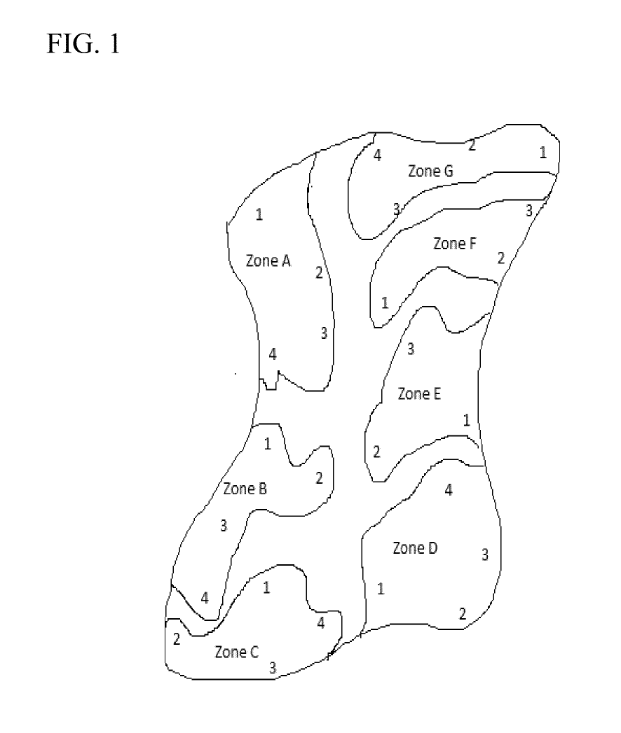

With reference to the theme park environment illustrated in FIG. 1, an exemplary itinerary for a patron who desires to partake of at least 20 rides on a single visit might follow the following sequence:

### A1, A2, A3, A4, B1, B2, B3, B4, C2, C1, C4, D1, D2, E1, E3, F1, F2, G1, G2 and G3.

Note that the patron according to this itinerary has actively elected to skip several attractions, i.e., C3, D3, D4, E2, F3 and G4. In spite of the fact that the patron following the schedule set forth above will partake of numerous attractions during their visit to the theme park, the patron will still have adequate time (and flexibility) to take rest stops, bathroom stops, meal stops, and the like, as desired.

### Example 2

### Sequential Schedule for a Patron Visiting 10 Attractions

With reference to the theme park environment illustrated in FIG. 1, an exemplary itinerary for a patron who desires to partake of only 10 rides on a single visit might follow the following sequence:

### F1, E3, E2, B2, B3, B1, A4, A3, A2 and A1.

Note that the patron according to this itinerary is starting in a different portion of the park, zone F, and has elected to skip a number of attractions, including zones C and D altogether. In spite of the fact that the patron following the schedule set forth above will partake of numerous attractions during their visit to the theme park, the patron will still have adequate time (and flexibility) to take rest stops, bathroom stops, meal stops, and the like, as desired.

### Example 3

### Sequential Schedule for a Patron Visiting 16 Attractions in 2 Adjacent Parks

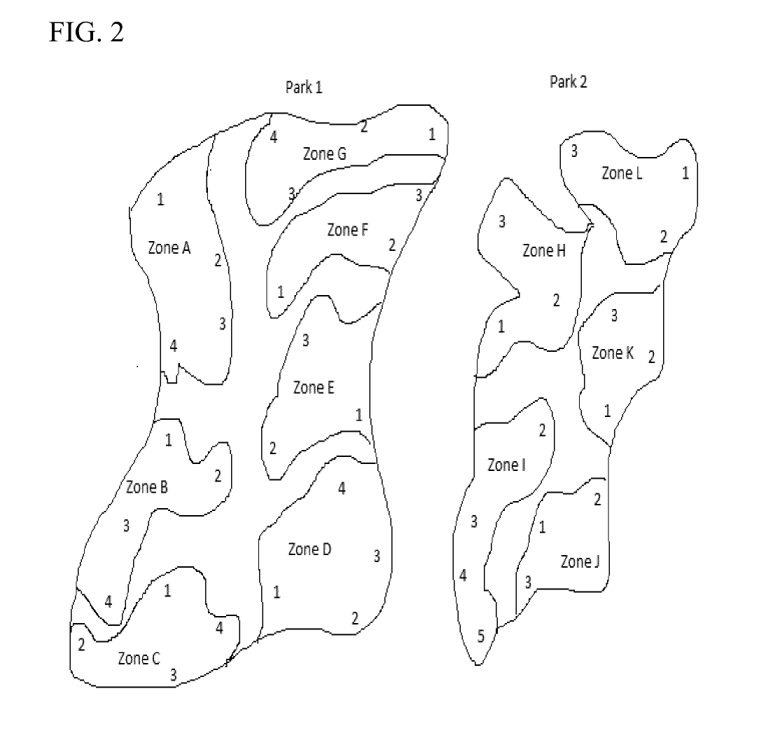

With reference to the theme park environment illustrated in FIG. 2, an exemplary itinerary for a patron who desires to partake of at least 16 attractions (located in adjacent parks) on a single visit to both parks, might follow the following sequence:

### B1, B4, C2, D1, D2, E2, G1, H3, I2, J1, J2, K1, K2, L2, L1 and L3.

This itinerary could be provided to the patron in a variety of forms, e.g., in tabular format as follows:

| Attraction/Event | Park | Time | |
|---|---|---|---|
| B1 | 1 | 9:15 | AM |
| B4 | 1 | 9:30 | AM |
| C2 | 1 | 9:45 | AM |
| D1 | 1 | 10:00 | AM |
| D2 | 1 | 10:15 | AM |
| E2 | 1 | 10:30 | AM |
| G1 | 1 | 10:45 | AM |
| H3 | 1 | 11:15 | AM |
| I1 | 1 | 11:30 | AM |
| Lunch | Open | 11:45 | AM |
| J1 | 2 | 1:00 | PM |
| J2 | 2 | 1:15 | PM |
| K1 | 2 | 1:30 | PM |
| K2 | 2 | 1:45 | PM |
| L2 | 2 | 2:00 | PM |
| Break/shopping/Open | 2 | 2:15 | PM |
| Activities | | | |
| L1 | 2 | 4:00 | PM |
| L3 | 2 | 4:15 | PM |
| Show X in Zone L | 2 | 4:30 | PM |
| Show Y in Zone L | 2 | 5:30 | PM |

| | | |
|---|---|---|
| Open | 1 and 2 | Until 9 PM |

Note that the patron according to this itinerary elected to start in zone 8 of park 1, and is efficiently scheduled to sequentially go through several selected attractions in park 1, followed by sequential visitation of selected attractions in park 2. Even though the schedule set forth above designates specific break times, the invention method is sufficiently flexible that the patron can readily alter the time(s) allotted for rest stops, bathroom stops, meal stops, and the like, as desired.

Although the invention is illustrated and described herein with reference to specific embodiments, the invention is not intended to be limited to the details shown. Rather, various modifications may be made in the details within the scope and range of equivalents of the claims without departing from the invention.

That which is claimed is:

1. A method for minimizing the wait time for admission of an individual patron or a plurality of patrons to a pre-selected plurality of attractions in a theme park environment,
wherein:
said theme park environment comprises a plurality of patrons seeking to partake of a plurality of attractions,
said plurality of attractions is selected from the group consisting of a ride, live entertainment, recorded entertainment, a restaurant, a snack bar, and a museum, but does not include golf, a hotel, a spa or a water park;
each attraction operates in either a batch-fill mode or constant throughput mode;
each attraction operating in a batch-fill mode has a pre-determined attraction capacity per run cycle, wherein each run cycle is of a pre-determined duration,
each attraction operating in a constant throughput mode allows for a range of transit times through said attraction;
each patron may optionally express one or more preferences regarding which attractions to visit and when, the sequence of attractions to visit, the time allotted between entry into each attraction, and, for attractions operating in the constant throughput mode, the time allotted to visit each such attraction, and
patrons are permitted access to each attraction on a priority basis established by a schedule which allocates report time(s) for each attraction, and optionally, for those who elect not to obtain boarding priority, on a first-in, first-out basis,
said method consisting essentially of:
transmitting to each patron, via a suitable vehicle, a schedule of report time(s) for one or more attraction(s) for which said patron would like to gain entry, wherein said suitable vehicle requires no park operator-supplied equipment; and wherein the schedule is established taking into account a plurality of the following criteria:
the number of patrons authorized to enter a given attraction at a given report time,
the duration of the run cycle for each attraction,
whether the attraction operates in a batch-fill mode or constant throughput mode,
when a request for priority boarding is submitted,
the patron's personal preferences; and
the relative distance between the attractions that the patron wishes to experience;
populating the attraction up to a pre-determined percentage of the attraction capacity with patrons having the allocated report time, without reserving space for patrons having the allocated report time who are not present at the attraction at the allocated time, and thereafter
optionally, at the operator's discretion, populating as much or as little of the remaining capacity of said attraction as deemed appropriate with patrons awaiting boarding on a first-in, first-out basis.

2. The method of claim 1 wherein the plurality of attractions are located in a plurality of zones about the theme park environment.

3. The method of claim 2 wherein it requires no more than 5 minutes to travel from a first attraction (or zone) to a second attraction (or zone).

4. The method of claim 2 wherein said plurality of attractions (or zones) are connected by some form of public transportation.

5. The method of claim 2 wherein the patron may elect to remain in a single zone within said theme park environment.

6. The method of claim 2 wherein the patron may elect the time of day in which to visit a specific zone.

7. The method of claim 2 wherein the patron can specify which zone(s) within the theme park environment the patron wishes to visit and when.

8. The method of claim 1 wherein the patron's personal preferences are self-booked, solicited at the time of ticket purchase, solicited at the time of entry to the theme park environment, solicited on-site after entry to the theme park environment, or attributed to each patron by default in the absence of explicit request.

9. The method of claim 1 wherein said theme park is equipped with a plurality of readily visible synchronized clocks.

10. The method of claim 1 wherein each patron may express a preference for one or more of the following:
which attractions to visit, and when to visit same,
the sequence with which attractions are visited,
designated companions with whom said patron wishes to coordinate schedules, and
requested stops.

11. The method of claim 1 wherein said vehicle which allows communication of said request to a centralized database is a map, a smart-phone, text message, or an email.

12. The method of claim 11 wherein said vehicle further comprises a timer, and/or a reminder alert.

13. The method of claim 1 wherein said centralized database monitors a plurality of the following parameters:
the number of patrons allowed to enter a given attraction,
the duration of the run cycle for each attraction,
the distance between attractions,
the volume of patrons in the theme park environment,
attractions which are unavailable on a given day,
attractions which are temporarily off-line,
attractions which are excessively congested, and
weather conditions (excessively hot day, excessively humid).

14. The method of claim 1 wherein no greater than 5% of the capacity of the attraction is populated by patrons having the allocated report time.

15. The method of claim 1 wherein no greater than 10% of the capacity of the attraction is populated by patrons having the allocated report time.

16. The method of claim 1 wherein no greater than 20% of the capacity of the attraction is populated by patrons having the allocated report time.

17. The method of claim 1 wherein no greater than 30% of the capacity of the attraction is populated by patrons having the allocated report time.

18. The method of claim 1 wherein no greater than 40% of the capacity of the attraction is populated by patrons having the allocated report time.

19. The method of claim 1 wherein no greater than 50% of the capacity of the attraction is populated by patrons having the allocated report time.

20. The method of claim 1 wherein said attraction is populated primarily by patrons having the allocated report time.

21. The method of claim 1 wherein said attraction is populated predominantly by patrons having the allocated report time.

22. The method of claim 1 wherein said attraction is populated exclusively by patrons having the allocated report time.

23. A method for minimizing the wait time for admission of an individual patron or a plurality of patrons to an attraction in a theme park environment,
wherein:
said theme park environment comprises a plurality of patrons seeking to partake of a plurality of attractions,
each attraction operates in either a batch-fill mode or constant throughput mode;
each attraction operating in a batch-fill mode has a pre-determined attraction capacity per run cycle, wherein each run cycle is of a pre-determined duration,
each attraction operating in a constant throughput mode allows for a range of transit times through said attraction;
each patron may optionally express one or more preferences regarding which attractions to visit and when, the sequence of attractions to visit, which zone(s) within the theme park environment the patron wishes to visit and when, the time allotted between entry into each attraction, and, for attractions operating in the constant throughput mode, the time allotted to visit each such attraction, and
patrons are permitted access to each attraction on a priority basis established on a first-in, first-out basis, or by a schedule which allocates report time(s) for each attraction,
said method consisting essentially of:
transmitting to each patron, via a suitable vehicle, a schedule of report time(s) for one or more attraction(s) for which said patron would like to gain entry, wherein the schedule is established taking into account the number of patrons authorized to enter a given attraction at a given report time, the duration of the run cycle for each attraction, when a request for priority boarding is submitted, and the patron's personal preferences;
populating the attraction up to a pre-determined percentage of the attraction capacity with patrons awaiting boarding on a first-in, first-out basis, and thereafter
optionally, at the park operator's discretion, populating as much of the remaining capacity of said attraction as deemed appropriate, with patrons having the allocated report time, without reserving space for patrons having the allocated report time who are not present at the attraction at the allocated time.

24. A method for managing the loading of a plurality of patrons on a plurality of attractions in a theme park environment,
wherein:
said theme park environment comprises a plurality of patrons seeking to partake of a plurality of attractions,
each attraction operates in either a batch-fill mode or constant throughput mode;
each attraction operating in a batch-fill mode has a pre-determined attraction capacity per run cycle, wherein each run cycle is of a pre-determined duration,
each attraction operating in a constant throughput mode allows for a range of transit times through said attraction;
each patron may optionally express one or more preferences regarding which attractions to visit and when, the sequence of attractions to visit, which zone(s) within the theme park environment the patron wishes to visit and when, the time allotted between entry into each attraction, and, for attractions operating in the constant throughput mode, the time allotted to visit each such attraction, and
patrons are permitted access to each attraction on a priority basis established by a schedule which allocates report time(s) for each attraction, and optionally, for those who elect not to obtain boarding priority, on a first-in, first-out basis,
said method consisting essentially of:
soliciting from each patron a priority request for allocation of report time(s) for one or more attraction(s) which said patron would like to experience, taking into account the number of patrons authorized to enter a given attraction at a given report time, the duration of the run cycle for each attraction, the time to be allotted between attractions, the number and location of the attractions of interest, when a request for priority boarding is submitted, and the patron's personal preferences, the priority request being entered into a centralized database that monitors the number of patrons allowed to enter a given attraction, and the duration of the run cycle for each attraction;
transmitting to each patron allocated report time(s) via a suitable vehicle,
populating the attraction up to a pre-determined percentage of the attraction capacity with patrons having the allocated report time, without reserving space for patrons having the allocated report time who are not present at the attraction at the allocated time, and thereafter
optionally, at the operator's discretion, populating the remaining capacity of said attraction with patrons awaiting boarding on a first-in, first-out basis.
